(19) United States
(12) Patent Application Publication
(10) Pub. No.: US 2011/0221963 A1
(43) Pub. Date: Sep. 15, 2011

(54) DISPLAY SYSTEM, CONTROL UNIT, METHOD, AND COMPUTER PROGRAM PRODUCT FOR PROVIDING AMBIENT LIGHT WITH 3D SENSATION

(75) Inventors: Filip Marcel Denise Bruyneel, Ledeberg (BE); Christophe Hoebeeck, Wetteren (BE); Dirck Seynaeve, Zedelgemneldegem (BE); Alfred Peeters, Oostkamp (BE); Petrus Johannes Hendrikus Seuntiens, Eindhoven (NL); Michael Verberne, Eindhoven (NL); Fei Zuo, Eindhoven (NL); Willem Franciscus Johannes Hoogenstraaten, Eindhoven (NL); Cornelis Wilhelmus Kwisthout, Eindhoven (NL)

(73) Assignee: KONINKLIJKE PHILIPS ELECTRONICS N.V., EINDHOVEN (NL)

(21) Appl. No.: 13/130,924

(22) PCT Filed: Nov. 24, 2009
(86) PCT No.: PCT/IB09/55313

§ 371 Date: May 24, 2011

(30) Foreign Application Priority Data
Nov. 28, 2008 (EP) 08170174.0

(51) Int. Cl. H04N 5/445; H04N 5/44

(52) U.S. Cl. 348/563; 348/553; 348/E05.12

(57) ABSTRACT

A display system having 3D ambient light functionality is provided. The system comprises at least light source for providing ambient light having color and/or intensity dependent on the image content. The system comprises a control unit configured to control the color and intensity of light emitted from each light source to produce a 3D-viewing sensation, at least partly based on depth information.

### FIELD OF THE INVENTION

The present invention pertains to the field of display devices having ambient light capabilities. In particular, the present invention pertains to a display system comprising a display device for showing image content, together with ambient light to increase the viewing experience of a viewer viewing the shown image content.

### BACKGROUND OF THE INVENTION

Display systems for enhanced viewing experience when watching video shown on a display device, such as a TV, by using light sources for projecting ambient light are known in the art.

A particularly interesting application is to project the ambient light on a wall using light sources surrounding the display device and/or projecting the ambient light towards a viewer.

Typically, the display device is a flat TV, which may hang on a surface, such as a wall, or placed in front of the surface. The display device may be provided with controllable light sources, such as Light Emitting Diodes, located adjacent to a display area or screen being capable of displaying images or video content. In use, the light sources may emit ambient light towards a surface behind the display device and/or towards a viewer in front of the display device.

In common ambient light display systems the intensity and color of the ambient light depends on the color information dominant in the content or portions thereof, particularly, the color of the content around the boundary of the contents shown on the display device. For example, if the video content near one side or edge of the display device has a green color, then green light is provided from light sources to backwash at least a region of the wall with green light. Similarly, if the video content near another side of the display device has a yellow color, then yellow light is provided from the light sources to backwash at least a region of the wall with yellow light. In this way different regions of the wall may simultaneously reflect light of different color at the same time.

The benefits of providing ambient light in general includes: a deeper and more immersive viewing experience, improved color, contrast and detail for best picture quality, and reduced eye strain for more relaxed viewing. Different advantages of backlighting require different settings of the backlighting system. Reduced eye strain may require slow changing colors and a more or less fixed brightness while more immersive viewing experience may require an extension of the screen content i.e. the same brightness changes with the same speed as the screen content.

However, a problem with current solutions is that the viewer, under some circumstances may experience the ambient light such as unrealistic.

Hence, and improved display system for providing ambient light would be advantageous.

### SUMMARY OF THE INVENTION

Accordingly, the present invention preferably seeks to mitigate, alleviate or eliminate one or more of the above-identified deficiencies in the art and disadvantages singly or in any combination and solves at least the above-mentioned problems by providing a display system, a device, a control unit, a method, and computer program product according to the appended patent claims.

An idea according to some embodiments is to control ambient light in a display system around a display device based on depth information. This may be achieved by controlling ambient light behind the display device based on the color and intensity of the object or objects being far away from the viewer and by controlling ambient light in front of the display device based on the color and intensity of the object or objects being close to the viewer.

According to an aspect a display system is provided. The display system comprises a display device for displaying image content comprised in an image signal. The display device further comprises a light source for providing ambient light. Moreover the display system comprises a control unit configured to control emission of ambient light from said light source based on light properties information of said image signal, and depth information obtainable from said image signal.

In another aspect a control unit is provided. The control unit is configured to control emission of ambient light from a light source based on light properties information of an image signal, and depth information obtainable from said image signal.

According to another aspect a method is provided. The method comprises receiving an image signal having image content. The method further comprises obtaining depth information of said image signal. Moreover, the method comprises controlling emission of ambient light of a light source based on light properties of said image content, and said depth information.

In yet another aspect a computer program product stored on a computer-readable medium comprising software code adapted to perform the steps of the method according to some embodiments when executed on a data-processing apparatus is provided.

An advantage according to an embodiment is that a more realistic viewing experience may be achieved for viewers viewing video content displayed on a display device, since a 3D-viewing sensation is provided. Depending on the depth position of an object in each image frame of the image signal the ambient light sources will be controlled differently. For example, light properties information of an object in a video signal flying towards the viewer “out of the display device” may at first be displayed in the rear back projection ambient light sources of the display system, and then optionally gradually pass on to the front projection ambient light sources when the object moves closer to the viewer. As the object moves closer to the viewer the rear back projection ambient light sources will decreasingly display light properties information of the object, and evidentially only display background image information when the object has passed a certain depth position. This will give the viewer a 3D sensation improving the experience that the object moves towards the viewer from a position far away and then passes the viewer.

### BRIEF DESCRIPTION OF THE DRAWINGS

These and other aspects, features and advantages of which the invention is capable of will be apparent and elucidated from the following description of embodiments of the present invention, reference being made to the accompanying drawings, in which

FIG. 1 is a block scheme showing a display system according to an embodiment;

FIG. 2a illustrates a display system according to an embodiment;

FIG. 2b illustrates a display system according to an embodiment;

FIG. 3a illustrates a display system according to an embodiment;

FIG. 3b illustrates a display system according to an embodiment;

FIG. 4 illustrates a display system according to an embodiment;

FIG. 5 illustrates a display system according to an embodiment;

FIG. 6 is a flowchart of a method according to an embodiment; and

FIG. 7 illustrates code segments of a computer program according to an embodiment.

### DESCRIPTION OF EMBODIMENTS

Several embodiments of the present invention will be described in more detail below with reference to the accompanying drawings in order for those skilled in the art to be able to carry out the invention. The invention may, however, be embodied in many different forms and should not be construed as limited to the embodiments set forth herein. Rather, these embodiments are provided so that this disclosure will be thorough and complete, and will fully convey the scope of the invention to those skilled in the art. The embodiments do not limit the invention, but the invention is only limited by the appended patent claims. Furthermore, the terminology used in the detailed description of the particular embodiments illustrated in the accompanying drawings is not intended to be limiting of the invention.

The term “ambient light” as used herein may be interpreted as, having properties, such as brightness, luminescence, color, or chrominance, being dependent on the image content presented on a display device, that may be displayed both towards a viewer (front projection) and/or away from the viewer (back projection), e.g. onto a wall behind the display device.

The term “ambient light device” is considered to be a device that may emit ambient light.

The following description focuses on an embodiment of the present invention applicable to a display device and/or display system having ambient light functionality.

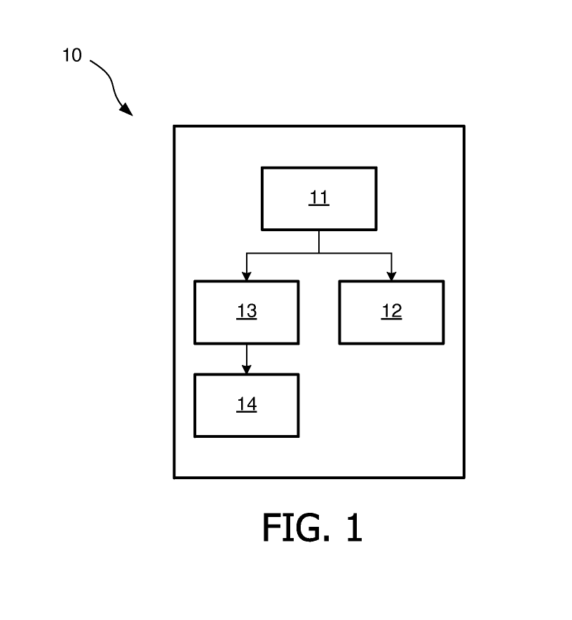

In an embodiment, according to FIG. 1, a display system 10 is provided. The display system 10 comprises a display device 12 for displaying image content based on an image signal 11. The display system 10 further comprises one or more light sources 14 for providing ambient light. Moreover, the display system 10 comprises a control unit 13 configured to control emission of ambient light from each light source 14 based on light properties information and depth information obtained from the image signal.

### Display Device

The display device may be a CRT-, LCD- or Plasma display, or any other display for displaying image content to a viewer.

### Ambient Light Sources and Light Properties

In an embodiment the light properties information of ambient light may be color, chrominance, intensity, or luminance, e.g. of a selected portion of the image content of the image signal. The selected portion may be a portion that when presented will be located near the border of the display region of the display device, thus containing information to optionally be presented in the ambient light.

In an embodiment the light sources may be one or more Light Emitting Diodes (LEDs) or any other light source capable of providing light visible to the human eye.

The light sources may be provided around the periphery of the display device along one or more sides of the display device, such as the left, right, top and/or bottom side.

The light sources may be divided into a plurality of individually controllable sets of lights.

The light sources may also be provided as separate light units, such as light ramps, that are freely moveable in a room, or the light sources may be lights fixedly mounted in a roof or wall of a room.

When the light sources are spread in 3D-space, they may be controlled to give a surround-light experience wherein objects traveling towards or away from the viewer may be individually controlled to produce a 3D-viewing sensation.

### Image Signal

In an embodiment the image signal is a video signal.

In an embodiment the image signal is a 3D content signal comprising information about objects and their respective positions, i.e. depth position, in each image frame.

### Depth Information

In an embodiment, the depth information may be obtained from the image signal, such as a 2D image using commonly known image analyzing algorithms. Commonly known video signals comprise only light information properties and no depth information, and accordingly they may be referred to as 2D video signals only comprising 2D image information. Using extraction algorithms the depth information may be extracted from the 2D image information and be utilized by the control unit 13 according to some embodiments of the invention.

In an embodiment, the depth information is extracted from the image signal using commonly known algorithms by approximation of depth positions of objects, background, or regions of each image frame, from consecutive image frames of the image signal.

Depth information related to a region of the image content gives information of how far away from the viewer the object(s) depicted in the region are.

In another embodiment the depth information is obtained from the image signal directly when the image signal comprises both image information and depth information. Such an image signal may be referred to as a 3D image or 3D video signal. An example of such a signal is a RGBD signal.

The depth information of the image signal pertains to information regarding the depth of each object, region, or pixel, in the image content. The depth information may thus be utilized in determining the relative depth position of a certain object compared to the background in each image frame. In the embodiments this depth information is taken into consideration by the control unit when controlling the light properties of the ambient light to be emitted by a light source(s).

In some embodiments, the depth information may be obtained from a RGBD signal or any other type of signal capable of giving depth information relating to image content.

It should be appreciated that the display system according to some embodiments is not limited to the way of obtaining depth information. Any means for obtaining depth information may be used.

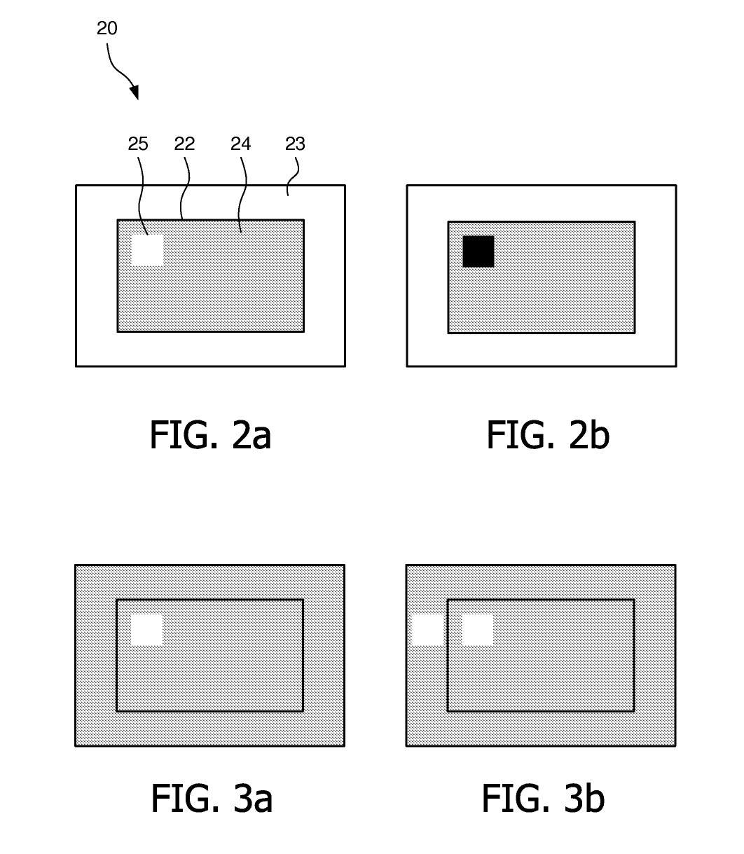

FIG. 2a illustrates a display system according to an embodiment. FIG. 2a shows a display region 22 of a display device 21 currently presenting an image frame comprising a gray background 24 and a white square object 25. Around the display region an array 23 of ambient light sources for displaying ambient light is provided.

FIG. 2b illustrates the display system according to FIG. 2a, wherein the display device presents a depth map 26 comprising the depth information of the image frame of FIG. 2a. From the depth map 26 it is evident that the square object 25 has a different depth compared to the background 24. In this case the square object 25 is located closer to the viewer than the background.

A depth map is generally a grey-scale image, wherein the intensity of a region of the map describes the depth of that region of the map. For example, the black region in the displayed depth map of FIG. 2b indicates that the square object 25 of the image frame shown in FIG. 2a is positioned near the viewer. If the square region of the video contents shown in FIG. 1 had been positioned distant from viewer the corresponding area of the depth map would have been white.

In an embodiment objects having a depth value higher than a predetermined value, i.e. objects being closer to the viewer than a predetermined depth position, are not taken into consideration when controlling the light properties of ambient light. Accordingly, instead of using the color or intensity of objects being located closer to the viewer in terms of said predetermined depth position, the color of the background is used for that specific area of the ambient light sources. This embodiment is advantageous for a display system being configured to provide back projection of ambient light such as to further visualize the relative depth differences between objects and the background in the image content.

This solution differs from current solutions since the depth information is not taken into consideration when controlling the light properties of the ambient light source. As such, objects located close to the border of the display region will always be presented in the ambient light regardless of their depth position. This makes the ambient light unrealistic under some circumstances.

FIG. 3a illustrates a display system according to FIG. 2a, in which the ambient light source array is configured to provide back projection. From FIG. 3a it may be observed that the ambient light sources to the left of the presented square object 25 does not emit white light from the square object towards the viewer, since the square object 25 is located closer to the viewer than the background.

In contrast, for a display system being configured to provide front projection, the objects having a depth position closer to the viewer than the predetermined depth position will be displayed in the ambient light to further visualize the relative depth differences between objects and the background in the image content.

FIG. 3b illustrates a display system according to an embodiment, in which the ambient light source array is turned on and configured to provide front projection. From FIG. 3b it may be observed that the ambient light sources to the left of the presented square object 25 emits white light towards the viewer, such as to extend the viewing experience of the presented image frame.

In a display system being configured to provide both front and back projection, the objects having a depth position closer to the viewer than the predetermined depth position will be displayed in the ambient light projected towards the viewer, i.e. in the front projection, while the background will be having a depth position further away from the viewer than the predetermined position will be displayed in towards a surface behind the display device, i.e. in the back projection.

### Gradient Between Object and Background Color

In an embodiment, the control unit is configured to calculate a relative depth difference between an object and the background, wherein the relative depth difference determines a ratio of object and background colors to be presented in the ambient light. Accordingly, a relative depth difference being close to zero indicates that the object and the background are located almost at the same depth. Under such conditions, a mixture of colors and/or intensities from both the object and the background could be presented in the ambient light.

With increasing relative depth difference between an object and the background, the colors and/or intensities of the background will be gradually increased in the back projection ambient light. The colors and/or intensities of the object may in such case be gradually increased in the front projection ambient light.

In an embodiment, the depth map may e.g. comprise depth values between −1 and 1, −1 being behind the viewer, 0 being just by the viewer and 1 being in front of the viewer. If the depth of a selected region of the image contents is closer to the viewer than a predetermined depth position, for example defined by depth value 0.3, the control unit chooses not to use the color of this region to influence the color of the ambient light projected behind the display device and instead use the average background color of surrounding regions being farther away from the viewer than a predetermined limit, for example 0.4. The predetermined limit may be a fixed depth or it may be adaptive to the depth scope of the current scene/scenes.

### Two or More Subsequent Image Frames

In an embodiment, the control unit is configured to utilize image content and depth information from at least two subsequent image frames to control the emission of an ambient light source. In this way information about e.g. the movement of an object may be taken into consideration when controlling the light properties to be emitted by an ambient light source, at a certain point in time. This embodiment is advantageous when objects are moving depth-wise in subsequent images, e.g. in a movie sequence in which an aeroplane flying towards the viewer.

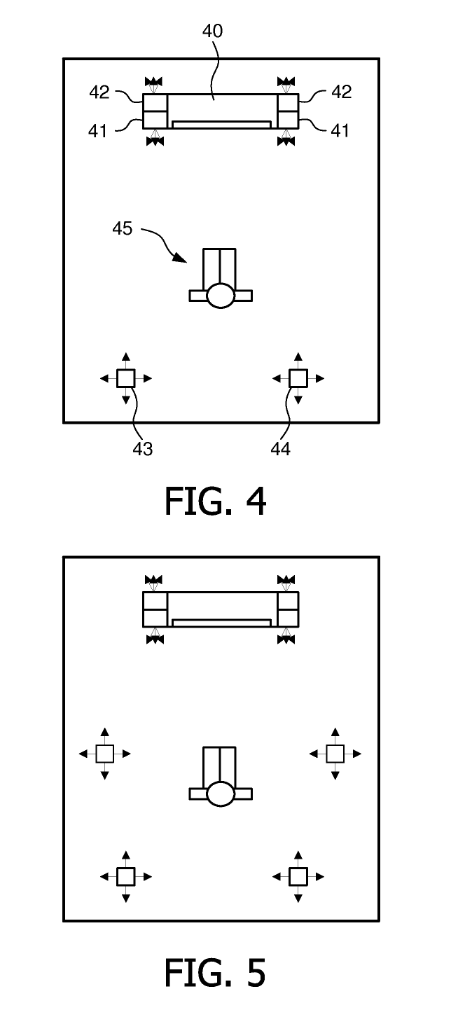

FIG. 4 illustrates a display system 40 according to an embodiment. The display system comprises a display device 41, a first ambient light array 41 for displaying front projection ambient light. The display system further comprises a second ambient light array 42 for displaying back projection ambient light. The display system further comprises two external light sources 43, 44 for providing ambient light. The two external light sources are used to display ambient light of objects and/or background located in front of a viewer 45. In this embodiment, two predetermined depth positions may be utilized by the control unit for controlling emission of ambient light. The first predetermined depth position may regard displaying of ambient light on the first and/or second ambient light array. The second predetermined depth position may regard displaying of ambient light on the first ambient light array and/or the two external ambient light sources.

In general, the color emitted from an ambient light source may be based on any brightness and/or color information in the image signal and/or depth information. This means that the emitted ambient light brightness and/or colors may exactly match the brightness and/or color in the image signal and/or depth information. Another option is that the brightness and/or color of emitted ambient light is based on an interpolation or have an off set with respect to the brightness and/or color at a predetermined depth position. The predetermined depth position may also be gradual, as explained above, with reference to the calculation of a depth difference.

Different settings of the controlling the brightness and/or color of the ambient light may be implemented in a viewer interface enabling a viewer to select a desired ambient light effect.

Any number of external light sources and spatial position thereof may be used. FIG. 5 illustrates a display system comprising four external ambient light sources.

In an embodiment, the emission of ambient light of an external ambient light source may be controlled by the control unit such that it is dependent on the spatial position the ambient light source. Accordingly, an external light source located next to the viewer, i.e. having approximately the same depth position as the viewer, will display objects or background having approximately the same depth position.

In an embodiment, an external light source is configured to emit ambient light being dependent on the background of each image frame at all points in time, except for when an object having a depth position being essentially the same as the depth position, i.e. based on spatial location, of the external light source, is detected in an image frame.

In an embodiment, an ambient light source is controlled, i.e. the ambient light emitted from the ambient light source is, based on analysis of a number of subsequent image frames of the image signal. For example, the ambient light emitted from an ambient light source may be based on brightness and/or color originating from an image frame not yet displayed on the display device. In another embodiment, the ambient light emitted from an ambient light source may be based on brightness and/or color originating from an image frame already displayed on the display device. For example, imagine a movie sequence of an aeroplane flying in from behind a viewer towards the viewer and then away from the viewer. In such a case, before the display device displays the first image frame comprising the aeroplane, the aeroplane color and intensity could be displayed in the back external ambient light sources 43, 44, then further on to the optional light sources located next to the viewer and then finally into the front projection ambient light sources simultaneous with the display region showing the aeroplane, and then into the back projection ambient light sources. This embodiment will increase the viewing experience drastically.

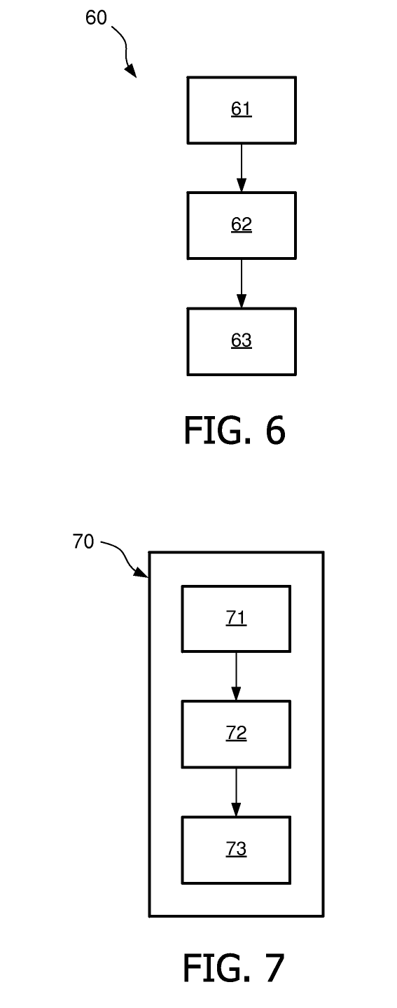

In an embodiment, according to FIG. 6, a method 60 is provided. The method comprises

receiving 61 an image signal comprising image content,

extracting 62 depth information of said image signal, and

controlling 63 emission of ambient light of a light source based on light properties of said image content, and said depth information.

In an embodiment, the method comprises steps for performing the functionality or functionalities of the display system according some embodiments.

In an embodiment, according to FIG. 7, a computer program product 70 stored on a computer-readable medium is provided. The computer program product comprises software code for processing by a data-processing apparatus. The software code comprises a code segment 71 for receiving an image signal comprising image content. The software code further comprises a code segment 72 for extracting depth information of said image signal. Furthermore, the software code comprises a code segment 73 for controlling emission of ambient light of a light source based on light properties of said image content, and said depth information.

In an embodiment a computer program product stored on a computer-readable medium comprising software code adapted to perform the steps of the method according to an embodiment when executed on a data-processing apparatus is provided.

In an embodiment a computer program product stored on a computer-readable medium comprising software code adapted to perform at least a functionality of the display system according to some embodiments when executed on a data-processing apparatus is provided.

Applications and use of the above described display system according to the invention are various and include exemplary fields such as home entertainment, cinemas, 3D-simulation, etc.

The control unit may be any device normally used for performing the involved tasks, e.g. a hardware, such as a processor with a memory.

The invention may be implemented in any suitable form including hardware, software, firmware or any combination of these. However, preferably, the invention is implemented as computer software running on one or more data processors and/or digital signal processors. The elements and components of an embodiment may be physically, functionally and logically implemented in any suitable way. Indeed, the functionality may be implemented in a single unit, in a plurality of units or as part of other functional units. As such, the invention may be implemented in a single unit, or may be physically and functionally distributed between different units and processors.

Although the present invention has been described above with reference to specific embodiments, it is not intended to be limited to the specific form set forth herein. Rather, the invention is limited only by the accompanying claims and, other embodiments than the specific above are equally possible within the scope of these appended claims.

In the claims, the term “comprises/comprising” does not exclude the presence of other elements or steps. Furthermore, although individually listed, a plurality of means, elements or method steps may be implemented by e.g. a single unit or processor. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second” etc do not preclude a plurality. Reference signs in the claims are provided merely as a clarifying example and shall not be construed as limiting the scope of the claims in any way.

1. A display system (10) comprising:
a display device (12) for displaying image content comprised in an image signal (11);
a light source (14) for providing ambient light; and
a control unit (13) configured to control emission of ambient light from said light source (14) based on light properties information of said image signal, and depth information obtainable from said image signal.

2. The display system according to claim 1, wherein said light information pertains to color, chrominance, intensity, or chrominance of a selected portion of said image signal.

3. The display system according to claim 1, wherein light properties related to the background of an image frame of said image signal is displayed by a first light source, and light properties related to a foreground object in said image frame is displayed by a second light source, wherein information of said background and said foreground object is comprised in said depth information.

4. The display system according to claim 1, wherein the light properties of the emitted ambient light, is partly based on the light properties related to the background of an image frame of said image signal, and partly based on the light properties related to a foreground object in said image frame, wherein information of said background and said foreground object is comprised in said depth information.

5. The display system according to claim 1, wherein the ambient light emitted from said first light source is dependent on the depth position of an object in image signal, wherein said depth position is comprised in said depth information.

6. The display system according to claim 1, wherein the ambient light emitted from said first light source is dependent on the depth position, being within a predetermined depth range, of an object in said image signal, wherein said depth position is comprised in said depth information.

7. The display system according to claim 1, wherein the ambient light emitted from said first light source is based on the spatial location of the first light source, the depth position of an object in image signal, and the light information properties of said object, wherein said depth position is comprised in said depth information.

8. The display system according to claim 1, wherein said image signal is a 2D video signal comprising image information, or a Red Green Blue Depth (RGBD) signal comprising image information and depth information relating to the image information.

9. The display system according to claim 1, wherein said first light source is configured to emit ambient light towards a viewer, said display system further comprising a second light source configured to emit ambient light away from a viewer, wherein light properties of objects having a depth position closer to a viewer than the predetermined depth position will be emitted by the first light source, and wherein the light properties of objects having a depth position further away from a viewer than the predetermined position will be emitted by the second light source.

10. The display system according to claim 1, wherein the control unit is configured to calculate a relative depth difference between an object and the background image information comprised in said image signal, wherein the relative depth difference determines a ratio of object and background brightness or colors to be emitted by said first light source, wherein information of said background and said foreground object is comprised in said depth information.

11. The display system according to claim 1, wherein the control unit is configured to utilize image content and depth information of an object comprised in said image signal from at least two subsequent image frames of said image signal to control the emission of ambient light from said light source.

12. A control unit (13) configured to control emission of ambient light from a light source (14) based on light properties information of an image signal (11), and depth information obtainable from said image signal.

13. A method (60) comprising
receiving (61) an image signal comprising image content,
obtaining (62) depth information of said image signal, and
controlling (63) emission of ambient light of a light source based on light properties of said image content, and said depth information.

14. A computer program product stored on a computer-readable medium comprising software code adapted to perform the steps of the method according to claim 12 when executed on a data-processing apparatus.
